(19) United States
(12) Patent Application Publication
(10) Pub. No.: US 2020/0061488 A1
(43) Pub. Date: Feb. 27, 2020

(54) FLUID-TREATMENT COLUMN WITH PARTITION

(71) Applicants: Robin SCHULZ, Kamen (DE); Helmut JANSEN, Dormagen (DE); Egon ZICH, Dormagen (DE); Thorsten Erik Alexander HUGEN, Essen (DE)

(72) Inventors: Robin SCHULZ, Kamen (DE); Helmut JANSEN, Dormagen (DE); Egon ZICH, Dormagen (DE); Thorsten Erik Alexander HUGEN, Essen (DE)

(21) Appl. No.: 16/531,509

(22) Filed: Aug. 5, 2019

(30) Foreign Application Priority Data
Aug. 24, 2018 (DE) 102018006707.7

(51) Int. Cl. B01D 3/14; B01D 3/00; B01J 19/24; B01J 19/02; B01J 19/30

(52) U.S. Cl. CPC B01D 3/141; B01D 3/009; B01J 19/2415; B01J 19/02; B01J 2219/0277; B01J 2219/00155; B01J 2219/0263; B01J 2219/0295; B01J 19/305

(57) ABSTRACT

A column for performing thermal separation processes and/or chemical reactions has a vertical outer wall that forms a chamber and a vertical partition subdividing the chamber into two compartments. The partition being formed by flat plates each being made of or covered by heat-insulating material.

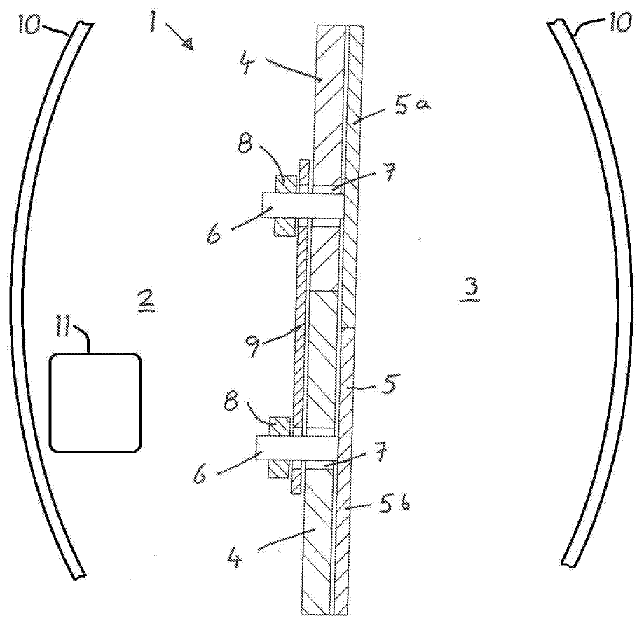

### FIELD OF THE INVENTION

The present invention relates to a fluid-treatment column. More particularly this invention concerns a partition for such a column.

### BACKGROUND OF THE INVENTION

A column for carrying out thermal separation processes and/or chemical reactions typically has a vertical and typically cylindrical outer wall that forms a chamber that is subdivided diametrally by at least one vertical and planar partition into at least two compartments of semicylindrical shape, the partition being formed by flat plates.

Columns with a vertical partition are known inter alia from U.S. Pat. No. 7,287,747, US 2018/0236371, and US 2018/0243664. In some applications of partition columns there is a temperature gradient between the two side faces of the partition (prefractionator and main column). This temperature gradient results in a transfer of heat from one side face to the other. As a result, liquid vaporizes on the “cold” side and steam condenses on the “hot” side. Both have a disadvantageous impact on the process.

### OBJECTS OF THE INVENTION

It is therefore an object of the present invention to provide an improved fluid-treatment column with a partition.

Another object is the provision of such an improved fluid-treatment column with a partition that overcomes the above-given disadvantages, in particular that reduces heat transfer from one side of the partition to the other side in a column having at least one vertical partition.

### SUMMARY OF THE INVENTION

A column for performing thermal separation processes and/or chemical reactions has a vertical outer wall that forms a chamber and a vertical partition subdividing the chamber into two compartments. The partition being formed by flat plates each being made of or covered by heat-insulating material.

In particular, a vertical partition in a cylindrical column subdivides the column interior into at least two part-cylindrical compartments in which different high temperatures can prevail, particularly in the vicinity of mass-transfer packs. Transfer of heat from one side of the partition to the other can lead to evaporation on one side and condensation on the other side, resulting in malfunctions and a poorer energy balance. This is substantially reduced by the heat-insulating materials of the partition.

A simple and efficient construction is provided if the plates are clad on one or both side faces with heat-insulating material(s). Preferably, the plates and/or their covering parts are made of plastic and/or ceramic. Furthermore, it is advantageous if the plastic has carbon fibers for reinforcement. It is also proposed that the plastic be a polytetrafluoroethylene (PTFE).

The plates are preferably connected to one another by screw and/or plug connectors. The plates are preferably encased in metal, and mass-transfer packs are provided in the compartments flanking the partition.

### BRIEF DESCRIPTION OF THE DRAWING

The above and other objects, features, and advantages will become more readily apparent from the following description, reference being made to the accompanying drawing in whose sole FIGURE a column partition is shown in section.

### SPECIFIC DESCRIPTION OF THE INVENTION

An unillustrated cylindrical column with a vertical cylindrical axis has a schematically illustrated cylindrical outer wall made of sheet metal of which two parts are illustrated not to scale at 10. It is internally divided by at least one generally planar and vertical partition 1 into two compartments 2 and 3 in which mass-transfer packs such as illustrated schematically at 11 are provided that ensure that thermal separation processes and/or chemical reactions occur between a liquid that is flowing in from above and a gas that is flowing in from below. In the embodiment shown in the drawing, the partition 1 is formed by sheet-metal plates 4 that are one above the other and can be welded together at the edges.

On one side, the supporting plates 4 are provided with a one-sided cladding 5 formed by tiles 5a and 5b that are made of a heat-insulating material, particularly plastic (for example PTFE) and/or ceramic, preferably with carbon fibers for reinforcement. Threaded pins 6 projecting laterally from the tiles 5a and 5b, extend through holes 7 in the plates 4, and carry nuts 8 on their free ends. A vertical brace plate 9 can be provided between the nuts and the plates 4.

Alternatively, the plates 4 themselves are made of heat-insulating material(s) and, furthermore, the plates can be connected to one another by plug connectors. Additional protection of the plates is achieved if the plates are encased in metal.

A specific embodiment of an insulated partition is described below:

In the case of a partition 1 made of stainless steel plates 4 with a thickness of 1.5 mm, heat transfer of 592 kW occurs between the two sides of the partition. If insulation cladding 5 of 5 mm thick PTFE is applied to this 1.5 mm-thick stainless steel sheet 4, the heat transfer drops to 14.4 kW. This corresponds to a reduction of 97.5%. It is crucial that the heat conduction of stainless steel be 15 W/(m K) and that the heat conduction of PTFE be 0.25 W/(m K). This observation applies to the assumption that steam is primarily responsible for the heat transfer on both side faces of the partition. Therefore, the heat transfer coefficient of the gas phases is assumed to be 5000 W/(m² K). Assuming that liquid is responsible for the transferred heat on both side faces of the partition, and in expectation of a heat transfer coefficient of 500 W/(m² K), heat flux of 72 kW occurs without isolation and 12.2 kW with insulation. This still corresponds to a savings of 83.1%.

1. A column for performing thermal separation processes and/or chemical reactions, the column comprising:
a vertical outer wall that forms a chamber; and
a vertical partition subdividing the chamber into two compartments, the partition being formed by flat plates each being made of or covered by heat-insulating material.

2. The column defined in claim 1, wherein the plates have opposite side faces at least one of which is clad with the heat-insulating material.

3. The column defined in claim 1, wherein the plates are at least partly made of plastic or ceramic.

4. The column defined in claim 1, wherein the plates are made of plasmic with carbon fibers for reinforcement.

5. The column defined in claim 1, wherein the plates are at least partly made of polytetrafluoroethylene.

6. The column defined in claim 1, further comprising:
screw connectors interconnecting the plates.

7. The column defined in claim 1, further comprising:
plug connectors interconnecting the plates.

8. The column defined in claim 1, wherein the plates are clad with metallic elements.

9. The column defined in claim 1, further comprising:
at least one mass-transfer pack in one of the compartments.
